(19) United States
(12) Patent Application Publication
(10) Pub. No.: US 2017/0284366 A1
(43) Pub. Date: Oct. 5, 2017

(54) WIND TURBINE ROTOR BLADE

(71) Applicant: BEST BLADES GMBH, Hamburg (DE)

(72) Inventor: Joerg Spitzner, Hamburg (DE)

(21) Appl. No.: 15/510,797

(22) PCT Filed: May 21, 2015
(86) PCT No.: PCT/DE2015/100205

§ 371 Date: Mar. 13, 2017

(30) Foreign Application Priority Data
Sep. 22, 2014 (EP) 14185815.9

(51) Int. Cl. F03D 7/02; F03D 1/06

(52) U.S. Cl. CPC F03D 7/022; F03D 1/0675; F03D 1/0633

(57) ABSTRACT

A wind turbine rotor blade (1) with a blunt, wide and/or cut off trailing edge (15) in a hub region (111), with an air-conducting channel (23) extending radially outward for conducting suctioned air from a suction region (21) to a blow-out region (22) arranged in the blade tip region (113) inside the wind turbine rotor blade (1), wherein and boundary layer suctioning occurs on the top side (13) of the wind turbine rotor blade (1), and a boundary layer fence (28) is provided in the hub region (111) near the hub fastening means (17) in order to prevent a flow in the direction of the hub fastening means (17).

The invention concerns a wind turbine rotor blade having a top side, a bottom side, a leading edge, a trailing edge, a hub fastening means, and a blade tip, wherein the wind turbine rotor blade is divided into a hub region, a center region, and a blade tip region, wherein a root region is defined from the hub fastening means to the maximum blade depth, wherein an air-conducting channel extending radially outward for conducting suctioned air from a suction region to a blow-out region arranged in the blade tip region is provided inside the wind turbine rotor blade and boundary layer suctioning occurs, wherein the suctioning of the air occurs on the top side of the wind turbine rotor blade, and a boundary layer fence is provided in the hub region near the hub fastening means in order to prevent a flow in the direction of the hub fastening means.

Various wind turbine rotor blades are known from the prior art in which various modifications are made with regard to their aerodynamic profile as well as with regard to the aerodynamic influence by boundary layer extraction, the aim of the optimization of wind turbine rotor blades always being the improvement of the total output of the wind energy installation.

In the following, the state of the art is considered in more detail:

The document DE 10 2008 052 858 B9 describes the profile of a rotor blade of a wind power installation with an top side (suction side) and a lower side (pressure side) with a skeleton line and a chord between the leading edge and the trailing edge of the profile, the relative profile thickness being more than 49%, the trailing edge is blunted, the skeleton line has an S-shape and runs in a section between 0% and 60% of the profiled depth of the profile beneath the chord, and the suction side and the pressure side of the profile have a concave contour in the rear region.

The document EP 2 182 203 B1 describes a rotor blade for a wind power installation comprising an original rotor blade and a blade tip extension connected thereto, characterized in that the blade tip extension comprises two fiber-glass reinforced half-shells which are glued to one another and to an end region of the original rotor blade.

The published document EP 2 292 926 A1 discloses a rotor blade of a wind power installation wherein the root region of the optimized rotor blade is optimally formed on the leading edge and/or the trailing edge so that a continuous progression of the rotor main region is achieved.

In the document EP 2 527 642, a rotor blade of a wind energy installation is described in which an air-conducting channel, which runs approximately radially outwards, is provided for conducting sucked air from a suction region arranged in the root region to a blow-off region, wherein boundary layer influencing, in particular boundary layer extraction, is to occur exclusively at the trailing edge.

The document DE 10 2008 003 411 A1 describes a family of wing profiles for a wind turbine blade. Each wing profile may include a blunt trailing edge, a substantially oval suction side, and a substantially S-shaped pressure side.

Furthermore, from publication WO 2007/035758 A1, a rotor blade with a boundary layer suctioning system is known and defined as follows: an air inlet located in the root region of the blade, an air outlet in the blade tip region, and a flow channel arranged inside the blade between the air inlet and the air outlet. With the aid of the centrifugal force prevailing by the rotary movement, the air is preferably sucked in at the air inlet and transported to the air outlet. The air is preferably compressed as it moves through the flow channel by centrifugal force. The boundary layer is sucked off at the surface of the rotor blade, the suction taking place substantially near the trailing edge or rather in an unplanned manner.

In the published document DE 10 2012 111 195 A1 a rotor blade arrangement for a wind energy installation is described, wherein the rotor blade arrangement includes: a rotor blade with outer surfaces, which define a pressure side, a suction side, a leading edge and an trailing edge, which each extend essentially in the tensioning direction between a rotor blade and a rotor blade tip and foot; and a blade enlarging device having a first panel and an opposing second panel, wherein both the first panel and the second panel have an inner surface and an outer surface each extending between a proximal end and a distal end, the distal end being defined by both the first panel and the second panel, with the first panel and the second panel spaced apart from the rotor blade substantially in the chord direction in a standard operating position.

A propeller is known from the publication CH 209 491, in which an independent boundary layer influencing takes place. On the surface of the inner area of the propeller, one or more suction areas are provided by means of slots which are connected to a blow-off area at the propeller tip by means of at least one air-conducting duct running radially outwards within the propeller. Via the rotation, the suctioned air is transported passively to the propeller tip with the aid of centrifugal force and is blown out there. In addition, it is possible to influence the transported air volumes via control valves and throttle valves.

The document EP 1 760 310 A1 discloses a rotor blade of a wind power installation, in which the rotor blade surface is significantly enlarged in the root region and thus a performance increase of the overall system results. The rotor blade profile is designed in the root region to be long and soft, so that a narrow trailing edge is formed in the root region. The total area of the rotor blade in the root region is hereby increased a number of times over conventional root regions of rotor blades.

Furthermore, from publication EP 2 204 577 A2, a rotor blade component is known which can be arranged at the trailing edge of the rotor blade for increasing the efficiency in the vicinity of the root region so that the power of the wind turbine installation on which the corresponding rotor blades are arranged can be operated more efficiently, wherein the mounting component with the rotor blade can be designed in the manner of a high-lift profile.

Reference is made to the general state of the art, in particular to the disclosure regarding the fluid dynamics of wind turbine rotor blades from the abovementioned printed publications.

The greatest problems with wind turbine rotor blades lie in the flow adjustment of the air flow at the top side of a wind turbine rotor blade. By optimizing the airflow, the efficiency of a wind turbine can be significantly increased.

However, the wind turbine rotor blades known in the prior art are not capable of realizing a further increase in efficiency, so that there is still a need for action to further improve the performance of a new or in particular also of existing wind energy installations.

The present invention is based on the object of improving a wind turbine rotor blade in its performance in such a way that the otherwise conventional and acceptable laminar to turbulent flow on the top side of the wind turbine rotor blade is significantly reduced or even reduced to zero and at the same time the efficiency is improved by change in the wind energy installation rotor blade geometry, wherein the transition point in which the laminar flow changes into a turbulent flow is to be displaced as far as possible to the trailing edge.

This object is achieved by a wind turbine rotor blade according to claim 1.

It has been recognized that after several years of use, wind turbine rotor blades have an individual and rotor blade geometry-dependent pollution zone on the top side, which is caused by environmental influences, and this starts only in a certain zone. This zone has been investigated in detail and it has been found that the flow through these wind turbine rotor blades known in the art at the initial point of contamination have an alteration in the flow of the air flowing over the surface of the top side. In this initial point of pollution the flow changes from laminar to turbulent, forming vortices that deposit dirt particles on the top of a wind turbine rotor blade.

Based on this initial situation and knowledge, the above-mentioned object has been solved with the following features of a wind turbine rotor blade, wherein at the same time the contamination of the top side of a wind turbine rotor blade can be reduced:

The trailing edge is blunt, wide and/or cut off in the hub region and at least in the first section of the central region connected thereto, and this runs out in the direction of the blade tip region, running along the root region in the direction of the blade tip.

Furthermore, the suction region is arranged in the region in which a laminar air flow separates from the top side of the rotor blade geometry in such a way that the laminar air flow is drawn towards the further surface of the top side, and the suction region starting at or near the boundary layer fence in the hub region extends into the central region, the suction region being guided over the root region in the direction of the blade tip in the central region.

By means of this embodiment, the boundary layer suction takes place exactly at the separation point of the laminar flow. The detachment begins approximately in the middle of a wind turbine rotor blade, but is different in the radial direction towards the outside, whereby the flow break edge approximately extends in the range of ⅓ to approximately ⅗ of the wind turbine rotor blade length into the trailing edge and runs into this.

In the case of a conversion of an existing rotor blade, the hub region is converted by means of corresponding mounting components, wherein by means of suction the laminar flow is caused to remain directed or attached to the new mounting part and in this way the hub region can be utilized for energy production. A substantial lengthening of the blade depth in the hub region has been found to be negative and does not lead to the desired increases in performance so that it is not just the increase in the area which brings about an increase in efficiency and associated energy production, but the application of the laminar flow up to or nearly up to the trailing edge. By this combination of features a very large surface area is simulated without this actually having to be built, wherein however at the same time a high energy gain with increases of up to 15% annual energy yield is realized.

The profile geometry of the wind turbine installation rotor blade in this case corresponds to a non-Wortmann-like profile and in no way to a Wortmann or Worthann-like profile, since the boundary layer extraction, for example with a profile geometry described in EP 1 760 310 A1, is not efficient and meaningful for technical reasons.

The boundary layer fence is also important, by which a limited profile start is formed and thus enables an aerodynamically favorable blade connection to the hub of a wind energy installation. Particularly in the case of conversions from existing wind turbine rotor blades to a wind turbine rotor blade according to the invention, there is no smooth transition to the original rotor blade geometry as the boundary layer fence now forms the terminus.

The wind turbine rotor blade profile to be used is designed in such a way that the region of the blunt, wide and/or cut-off trailing edge extends in the radial direction towards the blade tip over the maximum rotor blade depth, which leads to a definite increase in efficiency.

In contrast to EP 2 527 642 A1, the suction takes place at the detachment point of the laminar flow and not at the trailing edge of the wind turbine rotor blade. Rather, the suction in the detachment point is the decisive factor for achieving the higher efficiency. Similarly, the Wortmann- or Wortmann-like profile in combination with a blunt profile with the boundary layer suction must be avoided.

The positioning of the boundary layer suction is always performed as a function of the rotor blade geometry dependent separation boundary of the laminar flow, wherein this is essential both for in the conversions of existing wind turbine rotor blades as well as for the new construction wind turbine rotor blades.

In contrast to DE 10 2008 003 411 A1 as well as to WO 2007/035758 A1, the present profiled configuration is designed in such a way that the blunt, wide and/or cut-off trailing edge is led outwards over the point with a maximum blade depth in the radial direction to provide a noticeable increase in efficiency.

It is known that the region in which the laminar air flow transitions into turbulent air flow relocates when the rotor blade rotates, so that an adaptation of the suction line, ie, the region in which extraction takes place in the radial direction, may be necessary. This phenomenon is dependent on the incident velocity and the blade pitch angle.

The suction region has a plurality of openable and closable suction segments, which open and/or close as a result of relocation of the line at which laminar air flow separates from the top of the rotor blade, which is caused by rotation of the rotor blade on the hub for adapting the angle of attack of the rotor blade to the wind, and thereby the suction line also relocates.

By means of this embodiment, it is possible to carry out a very accurate tracking of the suction and thus to adapt the suction line to the angle of attack of the rotor blade on the basis of a rotor blade rotation, as is customary in modern plants. The relocating transition point or the relocating line of transition points is accompanied by a relocation of the suction by opening or closing individual suction segments.

The activation of the suction areas can take place depending on the angle of attack and the wind speed.

The maximum blade depth of the wind turbine rotor blade is provided in the hub region or in the first section of the central region, and the blade depth decreases from the maximum blade depth to the boundary layer fence.

The suction area is arranged in the surface section 40% of the local blade depth from the leading edge to 5% of the local blade depth from the trailing edge.

A very important aspect in the positioning of the radially arranged suction area at the top of the wind turbine rotor blade is that, initially starting at the boundary layer fence the suction area is arranged almost in the center of the rotor blade and only after the area of the maximum blade depth, depending on the specific rotor blade geometry, is it gradually migrating to the trailing edge, this being effected by the flow transition point, at which the laminar flow turns into turbulent flow.

It is, of course, possible to provide different suction area zones with air-conducting channels of different sizes, as a result of which further improvements are possible and which ultimately leads to different suction volumes, depending upon different rotational speed ranges.

The suction area in the hub area is arranged in the surface section 40% of the local blade depth from the leading edge to 30% of the local blade depth from the trailing edge.

The boundary layer fence(s) which are arranged, or are to be arranged, in particular, blended or continuous in the radius. However, the configuration is also possible in such a way that a transverse flow caused by the rotation is optimally supported in relation to the rotating rotor blade, the boundary layer fence being then not oriented following the radius but being guided quasi-transversely across the rotor blade.

A rotor blade known in the art is retrofitted by add-on components.

The blade inner body of the rotor blade is used as an air-conducting channel. It is not necessary to install a special tube within the rotor blade to transport the air from the hub to the blade tip. It is sufficient to seal the hub side of the rotor blade by means of a nearly air-tight, preferably completely airtight bulkhead, and to provide an outlet region in the region of the blade tip. Particularly preferably, a corresponding adaptation is made in the blade tip by means of an add-on part with an integrated air-conducting channel, as a result of which the volume flow is limited by the air-conducting channel in the blade tip, preferably also a valve can be provided there which regulates the suction and thus the passive boundary layer influencing.

The add-on components are segmented, whereby the direct mounting can be carried out at a wind power installation.

An important aspect is the conversion of existing systems, wherein in the case of a segmented design, two men can completely retrofit a system in just a few days, whereby all the essential components are provided in the segmented attachments and need only be laminated after grinding the existing wind turbine rotor blades.

The blade tip of a rotor blade known in the prior art is retrofitted by an add-on component that does not extend the rotor blade in its overall length.

As an alternative, the blade tip of a rotor blade known in the art can be retrofitted by an add-on component which extends the rotor blade in its total length by 0.5 to 7 m. In particular, winglets can be added or extended, as well as provided with corresponding blow-out region.

The segmented add-on components have at least one boundary layer fence section. In this embodiment, the segments can be joined to one another in the simplest manner without the need for very precise positioning. Each segment has a boundary layer fence or at least one boundary layer fence portion on at least one side so that the individual segments are bordered or limited aerodynamic surfaces.

A valve for controlling the boundary layer influencing is arranged in the air-conducting channel.

A method for controlling the output of a wind energy installation with presently claimed boundary layer suction applied comprises, in a power-free region, a starting region, a working region and a maximum output region, the features that
in the power-free region and/or in the maximum region no boundary layer suction,
a maximum available boundary layer suction in the start-up region and
in the working region, a variable boundary layer suction, starting with smaller power with a maximum boundary layer suction and ending with a minimal boundary layer suction at high power. This results in an additional improvement in wind turbine power efficiency in the lower power range as well as in the starting range, so that more energy can be produced at lower wind speeds. At the same time, an overload can be prevented at an early stage when the boundary layer suction is minimized. The method for controlling a wind energy installation is further improved in that the boundary layer suction is deactivated when a maximum rated power is reached. The achievement of a maximum rated power is already achieved at a lower wind speed, so that the use of the boundary layer influence can be stopped in time, since otherwise the generator of the wind energy installation would be destroyed or at least be damaged by too much power.

Conveying means are provided for active boundary layer influencing by air conduction within the air-conducting channel, so that air can be transported both from the suction area to the blow-out area as well as in the opposite direction.

The openings of the suction region and/or of the blow-out region are designed as bores and/or slots.

The entire improvements presented are in particular designed such that these are also to be interpreted as retrofitting components. In this way, as a whole, the add-on components are also claimed, which can improve a rotor blade of the standard design in such a way that a rotor blade is at least formed with the characteristics of the main claim. For this purpose, a first mounting part is designed in the root region in such a way that a mounting element can be placed on the normally circular root region and has a blunt trailing edge on which a suction area is provided. A second mounting part is provided for the area of the blade tip, so that a blow-out area is implemented here. A further part for the subsequent improvement of a standard rotor blade is the air-conducting channel introduced into the interior of the rotor blade. Standard fastening methods such as laminating, screwing, bonding, bolts or similar methods, all of which are known in the field of rotor blade technology, can be used for attaching the add-on components.

Exemplary embodiments of e invention are described in detail below with reference to the accompanying drawings.

Therein:

FIG. 1 is a schematic representation of an exemplary embodiment of a wind turbine rotor blade known in the prior art with the conversion according to the invention;

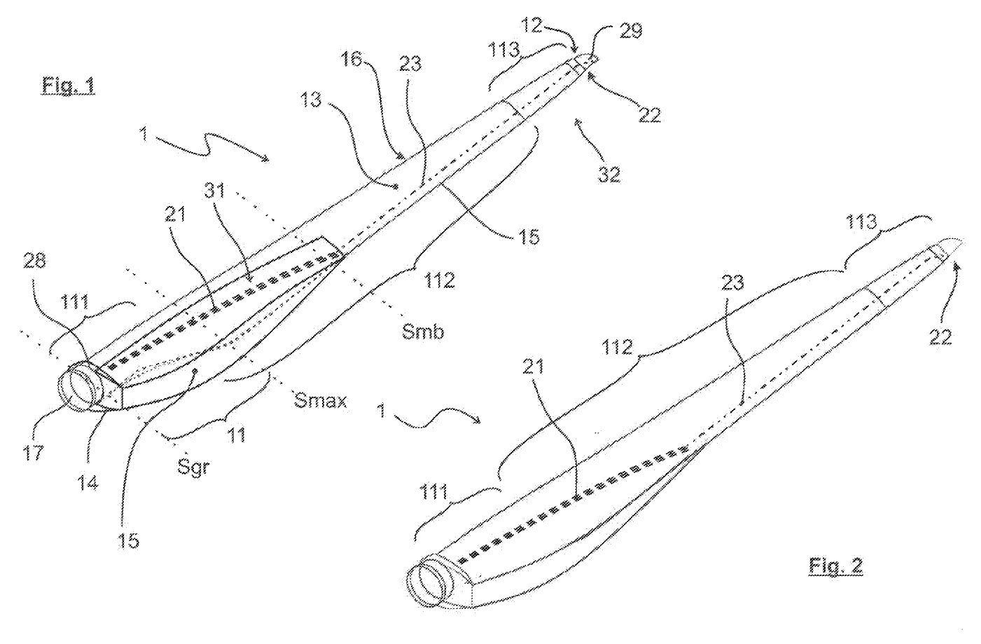

FIG. 2 is a schematic representation of a second exemplary embodiment of a wind energy turbine rotor blade as a new rotor blade;

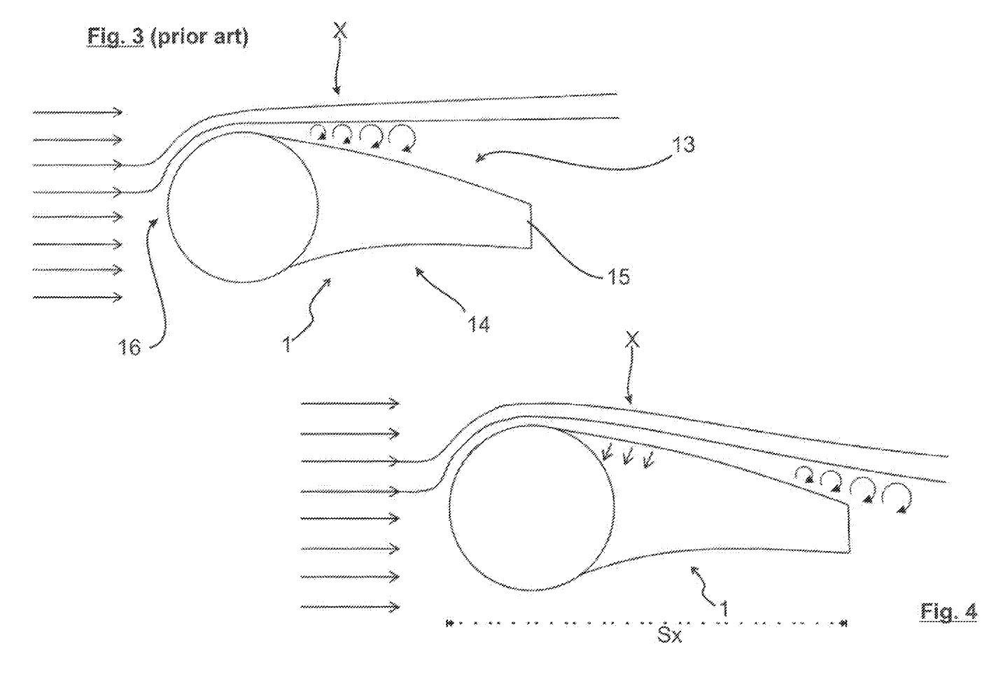

FIG. 3 shows a schematic cross-section of a wind turbine rotor blade known in the prior art, showing the flow and the transition point;

FIG. 4 shows a schematic cross-section of the wind turbine rotor blade according to the invention, showing the flow and the transition point;

FIG. 5 shows a schematic representation of a third exemplary embodiment of a wind turbine rotor blade in a segmented construction in a three-dimensional representation;

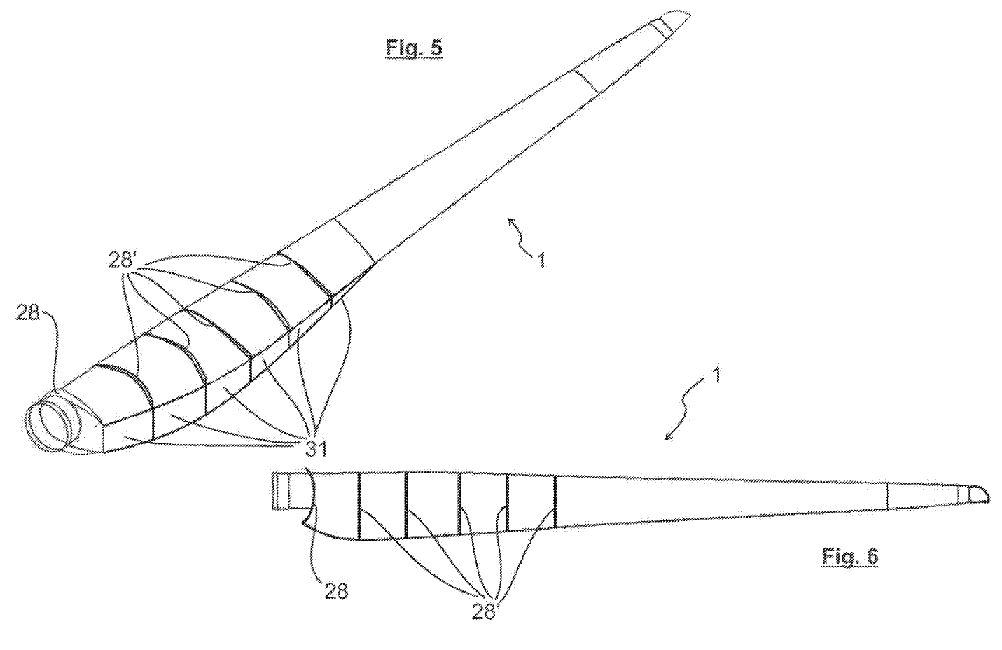

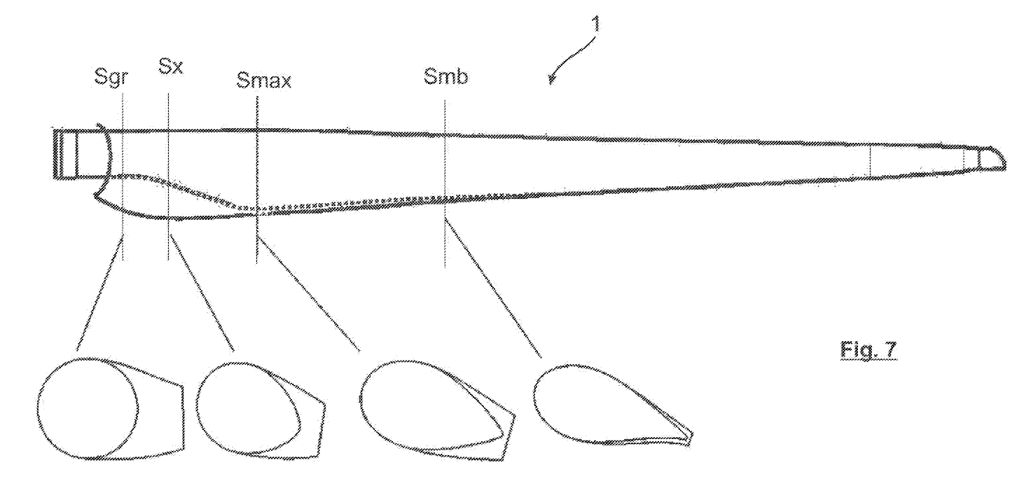

FIG. 6 is a schematic representation of the third exemplary embodiment of a wind turbine rotor blade, shown in FIG. 5, in a segmented construction in a top view;

FIG. 7 is a schematic representation of the wind turbine rotor blade shown in FIG. 1 with sections at different points of the wind turbine rotor blade with different blade depths;

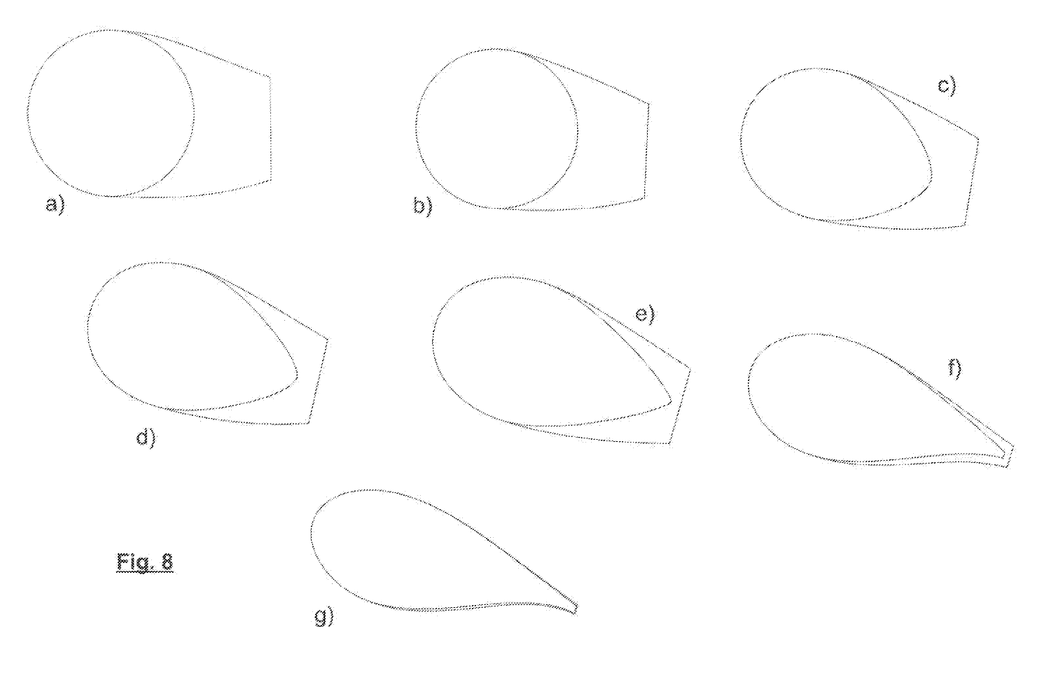

FIG. 8a) to g) are cross-sections through the wind turbine rotor blade shown in FIG. 1, with the ratios r/R= . . . , where a) is a section at 0.03, b) 0.05, c) 0.1, d) 0.2, e) 0.25, f) 0.3 and g) 0.4/0.5 spaced from the hub;

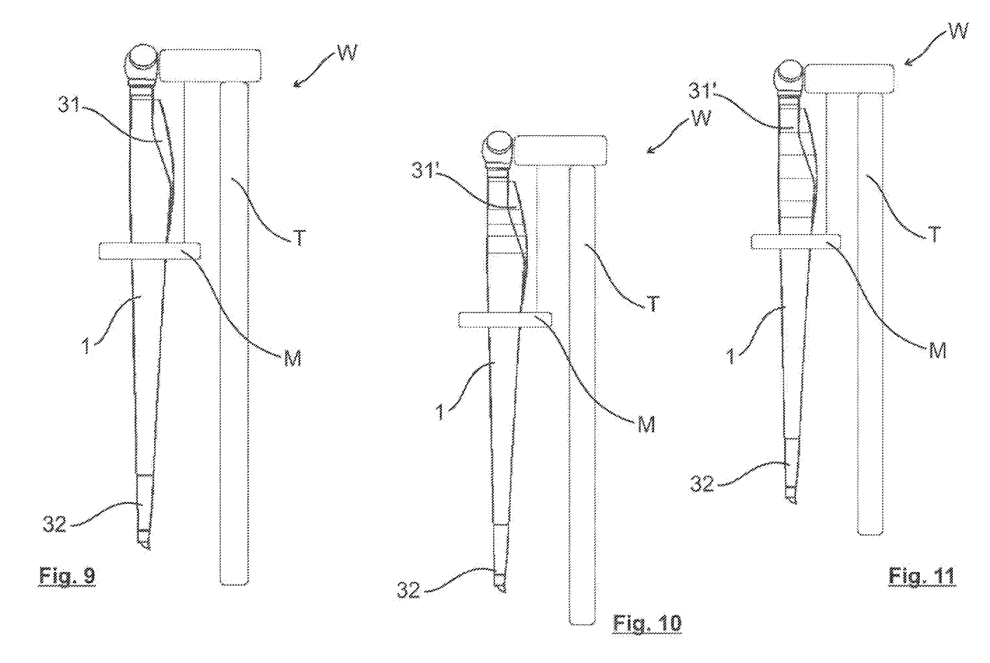

FIG. 9 shows a schematic illustration of a first exemplary embodiment of the wind energy turbine rotor blade according to the invention on a wind power installation;

FIG. 10 shows a schematic representation of a second exemplary embodiment of the wind turbine rotor blade according to the invention on a wind power installation, and FIG

FIG. 11 shows a schematic representation of a third exemplary embodiment of the wind energy turbine rotor blade according to the invention on a wind power installation.

FIG. 1 shows a schematic representation of an exemplary embodiment of a wind turbine rotor blade 1 known in the prior art, with the conversion according to the invention.

The wind energy turbine rotor blade 1 comprises a blade tip 12, a top side 13, a bottom side 14, a trailing edge 15, a leading edge 16 and a hub fastening means 17.

A suction component 31 with a suction area 21 provided therein as well as a blow-out component 32 with an extended rotor blade tip and winglet 29 are arranged on the existing wind turbine rotor blade 1. Furthermore, the air-conducting channel 23, which is arranged at the suction area 21 and is directed up to the blow-off area 22, is shown.

The wind energy turbine rotor blade 1 is divided into a hub region 111, a central region 112 and a blade tip region 113, which represent the respective wind turbine blade rotor sections.

In this illustration, the newly designed trailing edge 15, which has been reconfigured by the attached suction attachment part 31, is clearly visible. The trailing edge 15 is now designed to be blunt, wide and/or cut off starting from the new boundary layer fence 28 out to the transition point into the old trailing edge 15.

Furthermore, the arrangement of the suction area 21 can clearly be seen, which is not arranged as in the prior art on the trailing edge 15, on the top side 13 near the trailing edge 15, or undefined in the unclear areas of the top side 13, but rather is arranged along a transition point line in which the laminar flow of the air surrounding the wind energy turbine rotor blade 1 turns into a turbulent flow.

Only by means of this very special configuration is a considerable increase in efficiency possible compared to the known wind turbine rotor blades.

In the following, the same reference symbols as in FIG. 1 are used for the same elements. Reference is made to FIG. 1 for their principal function.

FIG. 2 shows a schematic illustration of a second exemplary embodiment of a wind turbine rotor blade 1 as a new rotor blade.

The suction region 21, the blow-out region 22 and the air-conducting channel 23 are shown.

FIG. 3 shows a schematic cross-section of a wind turbine rotor blade 1 known in the prior art, showing the flow and the transition point X.

At the transition point X, the initially laminar airflow begins to turn into a turbulent air flow, which leads to a worsening of the efficiency and also to an increased contamination of the top side 13 of the wind turbine rotor blade 1.

FIG. 4 shows a schematic cross section of the wind turbine rotor blade 1 according to the invention, showing the flow and the transition point X.

By means of the suction provided in the suction area 21 in combination with the blunt, wide and/or cut-off trailing edge 15 of the wind turbine rotor blade 1, the air flow which is still laminar remains attached at the transition point X to the additional flat element, whereby the energy yield of the overall wind energy installation W is increased by 15%. The turbulent flow does not develop until much later and, in combination with the blunt, wide and/or cut-off trailing edge 15, leads to a further increase in the energy output yield of the wind energy installation W.

FIG. 5 shows a schematic representation of a third exemplary embodiment of a wind turbine rotor blade 1 in a segmented construction embodiment in a spatial representation.

Six segments of the suction component 31 are installed on a wind turbine rotor blade 1 to be converted. Each of these segments 31 has a boundary layer fence 28 or 28′ on the left-hand side in the front-edge direction. During assembly, for example, in the open field, good transitions can be realized from an aerodynamic viewpoint as well as from a montage view.

FIG. 6 shows a schematic representation of the third embodiment of a wind turbine rotor blade 1 shown in FIG. 5 in a segmented construction embodiment in a top view of the top side 13.

FIG. 7 shows a schematic representation of the wind turbine rotor blade 1 shown in FIG. 1 with sections at different points of the wind turbine rotor blade 1 with different blade depths Smax, Sgr, Smb, Sx.

FIG. 8a) to g) show cross sections through the wind turbine rotor blade shown in FIG. 1 with the ratios r/R= . . . , where a) a section at 0.03, b) 0.05, c) 0.1, d) 0.2, e) 0.25, f) 0.3 and g) 0.4/0.5 spaced from the hub.

In this case, the larger circumferences of the cross sections represent the new design and the smaller cross sections the original design of an upgraded wind turbine rotor blade 1.

FIGS. 9, 10 and 11 show schematic illustrations of three exemplary embodiments of the wind turbine rotor blade 1 according to the invention on a wind power installation W.

The wind energy installation W consists of a wind turbine tower T mounted on a foundation, a generator housing mounted on the wind energy tower T, on which a hub with three wind turbine rotor blades 1 arranged thereon is provided.

In order to convert existing wind energy installations W, an assembly device M or work platform can be lowered from the generator housing or, alternatively, be raised from the below and raised up the wind energy installation tower T or to the wind energy turbine rotor blade 1 in order to connect the suction attachment part 31 or the segmented add-on part 31′ or as the case may be the blow-out component 32 as well as the air-conducting channel 23 (not shown).

### REFERENCE LIST

1 Wind energy turbine rotor blade

11 Root region

111 Hub region

112 Center region

113 Blade tip region

12 Blade tip

13 Top side

14 Bottom side

15 Trailing edge

16 Leading edge

17 Hub fastening means

21 Extraction area

22 Blow out area

23 Air-conducting channel

28, 28′ Boundary layer fence

29 Winglet

31, 31′ Suction component

32 Air blow-out component

M Mounting device

Smax Maximum blade depth/shoulder depth

Sgr Blade/shoulder depth in the area of the boundary layer

Smb Blade/shoulder depth in the area of the center region

Sx Local blade depth at the point of the rotor blade

T Wind energy tower

W Wind energy installation

X Transition point laminar into turbulent flow

→ Airflow

1. A wind turbine rotor blade (1) having a top side (13), a bottom side (14), a leading edge (16), a trailing edge (15), a hub fastening means (17) and a blade tip (12) wherein the wind turbine rotor blade (1) has a hub region (111), a center region (112), and a blade tip region (113), and wherein a root region (11) is defined from the hub fastening means (17) to the maximum blade depth (Smax), wherein
an air-conducting channel (23) is provided inside the wind turbine rotor blade (1) extending radially outward for conducting suctioned air from a suction region (21) to a blow-out region (22) arranged in the blade tip region (113), and a boundary layer suctioning occurs in a suction area (21) where a suctioning of the air from the top side (13) of the wind turbine rotor blade (1) occurs,
a boundary layer fence (28) is provided in the hub region (111) near the hub fastening means (17) in order to prevent a flow in the direction of the hub fastening means (17),
the trailing edge (15) in the hub region (111) and at least in the first section of the central region (112) connected thereto is blunt, wide and/or cut off running in the direction of the blade tip region (113), wherein this continues in the root region (11) towards the direction of the blade tip (12),
the suction area (21) is arranged in the area in which a laminar air flow detaches from the top side (13) based on the rotor blade geometry, so that an attachment and continuation of laminar air flow along the top side (13) occurs, and
the suction area (21) starting at or near the boundary layer fence (28) in the hub area (111) extends into the central region (112), wherein the suction area (21) extends over the root region (11) in the direction of the blade tip (12) in the center region (112).

2. The wind energy turbine rotor blade (1) according to claim 1, wherein the suction area (21) includes a plurality of openable and closable suction segments which can be opened and/or closed as a function of a relocation of the point at which laminar flow changes to turbulent (X) on the top surface (13) due to rotor blade geometry, which migrates due to a rotation of the rotor blade at the hub for adapting the angle of attack of the rotor blade to the wind, whereby a changeable suction line is formed.

3. The wind energy turbine rotor blade (1) according to claim 1, wherein the maximum blade depth (Smax) of the wind turbine rotor blade (1) is provided in the hub region (111) or in the first section of the central region (112) and the blade depth (Sgr) decreases from the maximum blade depth (Smax) to the boundary layer fence (28).

4. The wind energy turbine rotor blade (1) according to claim 1, wherein the suction area (21) is arranged in the section of the surface from 40% of the local blade depth (Sx) from the leading edge (16) to 5% of the local blade depth (Sx) from the trailing edge (15).

5. The wind energy turbine rotor blade (1) according to claim 4, wherein the suction area (21) in the hub region (111) is arranged in the section of the surface from 40% of the local blade depth (Sx) from the leading edge (16) to 30% of the local blade depth (Sx) from the trailing edge (15).

6. The wind energy turbine rotor blade (1) according to claim 1, wherein the blade inner body of the rotor blade (1) is used as an air-conducting channel.

7. The wind energy turbine rotor blade (1) according to claim 1, wherein a conventional rotor blade is retrofitted with add-on components.

8. The wind energy turbine rotor blade (1) according to claim 7, wherein the add-on components are segmented.

9. The wind energy turbine rotor blade (1) according to claim 1, wherein the blade tip (12) of a rotor blade known in the prior art is retrofitted with an add-on component which does not extend the rotor blade overall length.

10. The wind energy turbine rotor blade (1) according to claim 1, wherein the blade tip (12) of a conventional rotor blade is retrofitted by an extension component which extends the rotor blade in its total length by 0.5 to 7 m.

11. The wind energy turbine rotor blade (1) according to claim 8, wherein the segmented cultivating components have at least one boundary layer fence portion (28, 28′).

12. The wind energy turbine rotor blade (1) according to claim 1, wherein a valve for controlling the boundary layer influencing is arranged in the air-conducting channel (23).

13. The wind energy turbine rotor blade (1) according to claim 1, wherein transport means are provided for actively influencing the boundary layer by means of air conduction within the air-conducting channel (23), so that air can be transported both from the suction area (21) to the blow-out area (22) as well as in the opposite direction.

14. The wind energy turbine rotor blade (1) according to claim 1, wherein the openings of the suction region (21) and/or of the blow-out region (22) are designed as bores and/or slots.
